(19) United States
(12) Patent Application Publication
(10) Pub. No.: US 2011/0077373 A1
(43) Pub. Date: Mar. 31, 2011

(54) POLYMER AND OPTOELECTRONIC DEVICE COMPRISING THE SAME

(75) Inventors: Qing Ye, Los Gatos, CA (US); Jie Liu, Niskayuna, NY (US); Kelly Scott Chichak, Clifton Park, NY (US)

(73) Assignee: GENERAL ELECTRIC COMPANY, Schenectady, NY (US)

(21) Appl. No.: 12/569,286

(22) Filed: Sep. 29, 2009

(51) Int. Cl. C08G 73/00

(52) U.S. Cl. 528/8

(57) ABSTRACT

A polymer useful in an optoelectronic device comprises structural unit of formula I:

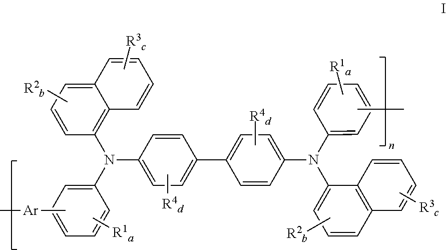

wherein
Ar is heteroaryl or aryl, other than formula I;
R¹, R², R³ and R⁴ are, independently at each occurrence, a C₁-C₂₀ aliphatic radical, a C₃-C₂₀ aromatic radical, or a C₃-C₂₀ cycloaliphatic radical;
a, c and d are, independently at each occurrence, an integer ranging from 0-4;
b is an integer ranging from 0-3; and
n is an integer greater than 3.

### BACKGROUND

The invention relates generally to polymers useful, e.g., as hole-transporting materials and/or electron blocking materials of optoelectronic devices, and the optoelectronic devices comprising the polymers.

Optoelectronic devices, e.g. Organic Light Emitting Devices (OLEDs), which make use of thin film materials that emit light when subjected to a voltage bias, are expected to become an increasingly popular form of flat panel display technology. This is because OLEDs have a wide variety of potential applications, including cell phones, personal digital assistants (PDAs), computer displays, informational displays in vehicles, television monitors, as well as light sources for general illumination. Due to their bright colors, wide viewing angle, compatibility with full motion video, broad temperature ranges, thin and conformable form factor, low power requirements and the potential for low cost manufacturing processes, OLEDs are seen as a future replacement technology for cathode ray tubes (CRTs) and liquid crystal displays (LCDs). Due to their high luminous efficiencies, OLEDs are seen as having the potential to replace incandescent, and perhaps even fluorescent, lamps for certain types of applications.

OLEDs possess a sandwiched structure, which consists of one or more organic layers between two opposite electrodes. For instance, multi-layered devices usually comprise at least three layers: a hole injection/transport layer, an emissive layer and an electron transport layer (ETL). Furthermore, it is also preferred that the hole injection/transport layer serves as an electron blocking layer and the ETL as a hole blocking layer. Single-layered OLEDs comprise only one layer of materials between two opposite electrodes.

### BRIEF DESCRIPTION

In one aspect, the invention relates to a polymer comprising structural unit of formula I:

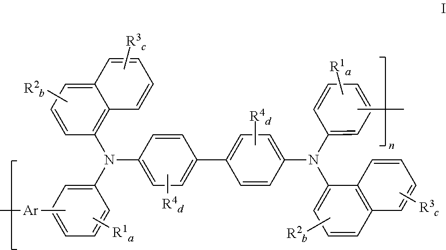

wherein

Ar is heteroaryl or aryl, other than formula I;

R¹, R², R³ and R⁴ are, independently at each occurrence, a C₁-C₂₀ aliphatic radical, a C₃-C₂₀ aromatic radical, or a C₃-C₂₀ cycloaliphatic radical;

a, c and d are, independently at each occurrence, an integer ranging from 0-4;

b is an integer ranging from 0-3; and

n is an integer greater than 3.

In another aspect, the invention relates to an optoelectronic device comprising the above polymer.

### DETAILED DESCRIPTION

In one aspect, the invention relates to a polymer comprising structural unit of formula I:

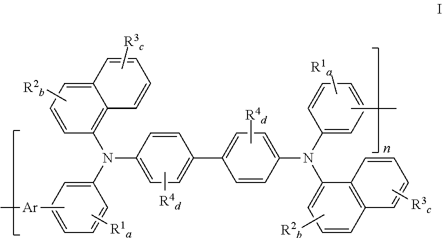

wherein

Ar is heteroaryl or aryl, other than formula I;

R¹, R², R³ and R⁴ are, independently at each occurrence, a C₁-C₂₀ aliphatic radical, a C₃-C₂₀ aromatic radical, or a C₃-C₂₀ cycloaliphatic radical;

a, c and d are, independently at each occurrence, an integer ranging from 0-4;

b is an integer ranging from 0-3; and

n is an integer greater than 3.

In another aspect, the invention relates to an optoelectronic device comprising the above polymer.

In some embodiments, the polymer comprises structural unit of formula II:

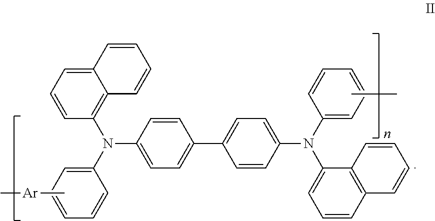

In some embodiments, Ar is selected from

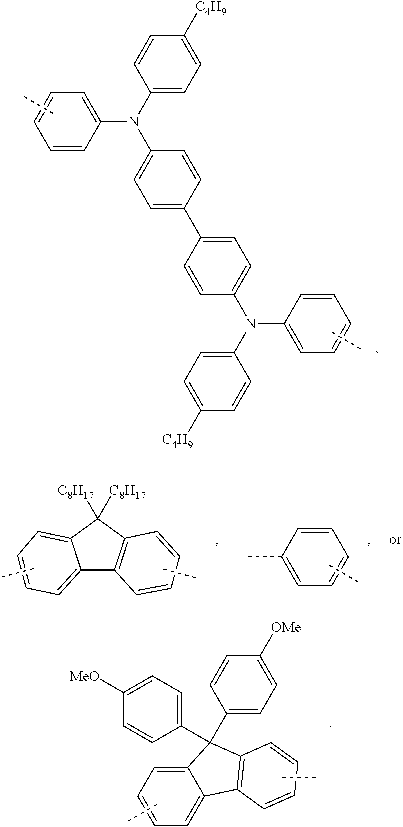

In some embodiments, the polymer comprises structural unit of formula

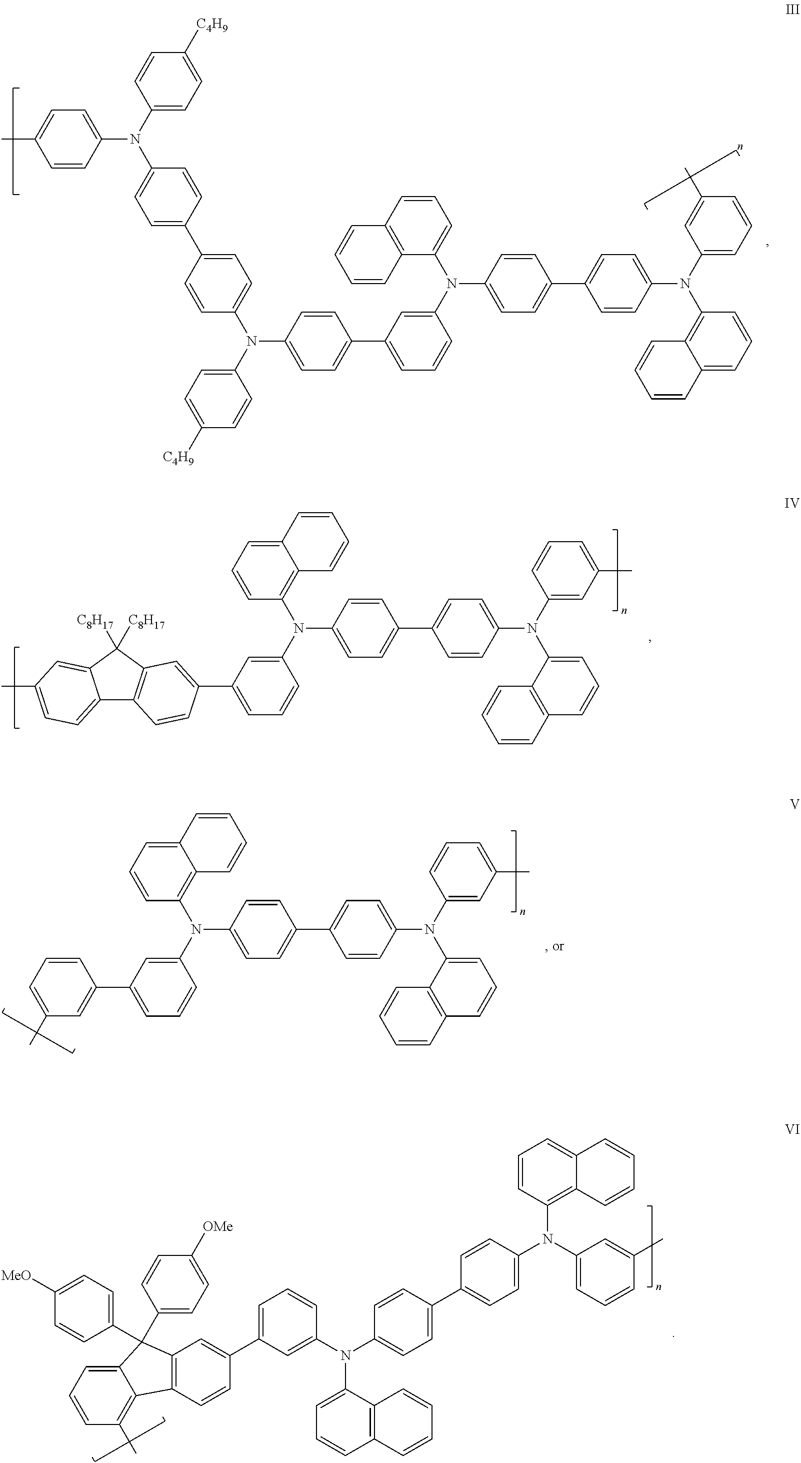

In some embodiments, the polymer comprises structural units derived from

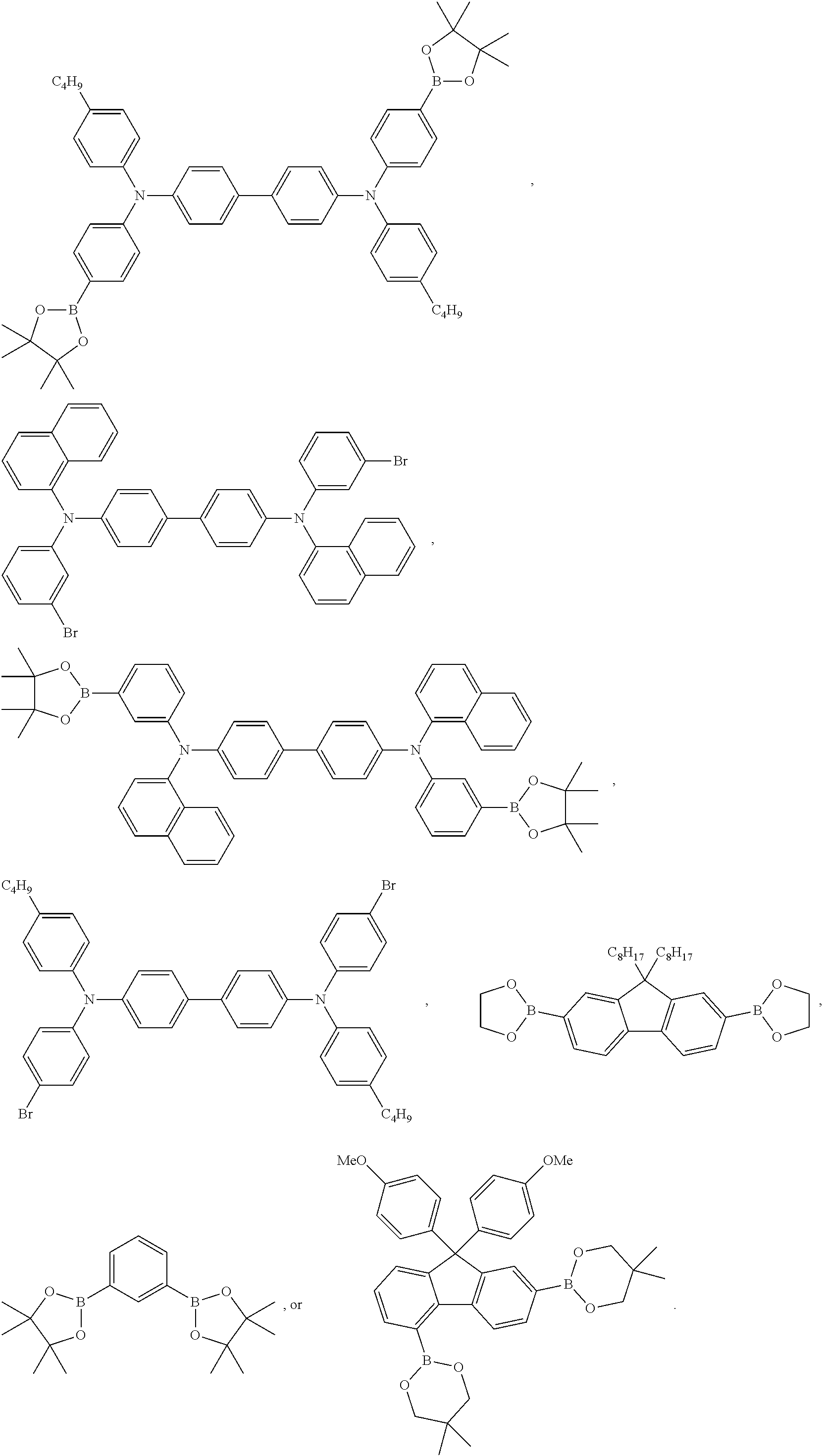

The polymers are made by processes comprising Suzuki cross-coupling reactions in a suitable solvent, in the presence of a base and Pd catalyst. The reaction mixture is heated under an inert atmosphere for a period of time. Suitable solvents include but are not limited to dioxane, THF, EtOH, toluene and mixtures thereof. Exemplary bases include KOAc, Na₂CO₃, K₂CO₃, Cs₂CO₃, potassium phosphate and hydrates thereof. The bases can be added to the reaction as a solid powder or as an aqueous solution. The most commonly used catalysts include Pd(PPh₃)₄, Pd₂(dba)₃, or Pd(OAc)₂, Pd(dba)₂ with the addition of a secondary ligand. Exemplary ligands include dialkylphosphinobiphenyl ligands, such as structures VII-XI shown below, in which Cy is cyclohexyl.

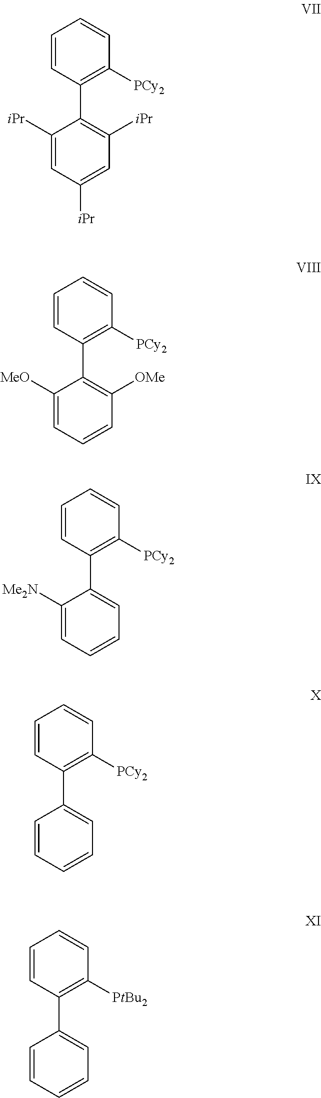

In certain embodiments, the polymerization reaction is conducted for a time period necessary to achieve a polymer of a suitable molecular weight. The molecular weights of a polymer is determined by any of the techniques known to those skilled in the art, and include viscosity measurements, light scattering, and osmometry. The molecular weight of a polymer is typically represented as a number average molecular weight Mn, or weight average molecular weight, Mw. A particularly useful technique to determine molecular weight averages is gel permeation chromatography (GPC), from which both number average and weight average molecular weights are obtained. Molecular weight of the polymers is not critical, and in some embodiments, polymers of Mw greater than 30,000 grams per mole (g/mol) are desirable, in other embodiments, polymers of Mw greater than 50,000 g/mol are desirable, while in yet other embodiments, polymer of Mw greater than 80,000 g/mol are desirable.

Those skilled in the art will understand that the phrase “as determined by gel permeation chromatography relative to polystyrene standards” involves calibration of the GPC-instrument using polystyrene molecular weight standards having a known molecular weight. Such molecular weight standards are commercially available and techniques for molecular weight calibration are routinely used by those skilled in the art. The molecular weight parameters referred to herein contemplate the use of chloroform as the solvent used for the GPC analysis as reflected in the experimental section of this disclosure.

Polymers comprising structural unit of any of formula I-VI have back bones comprising only electroactive moieties that could provide a continuous path for charges and have a good morphology in films, so polymers comprising structural unit of any of formula I-VI is useful, e.g., in optoelectronic devices, such as organic light emitting devices (OLEDs), and are particularly well suited for use as hole transporting materials and electron blocking materials for OLEDs.

An optoelectronic device, e.g., an OLED, typically includes in the simplest case, an anode layer and a corresponding cathode layer with an organic electroluminescent layer disposed between said anode and said cathode. When a voltage bias is applied across the electrodes, electrons are injected by the cathode into the electroluminescent layer while electrons are removed from (or “holes” are “injected” into) the electroluminescent layer from the anode. Light emission occurs as holes combine with electrons within the electroluminescent layer to form singlet or triplet excitons, light emission occurring as singlet and/or triplet excitons decay to their ground states via radiative decay.

Other components which may be present in an OLED in addition to the anode, cathode and light emitting material include a hole injection layer, an electron injection layer, and an electron transport layer. The electron transport layer need not be in direct contact with the cathode, and frequently the electron transport layer also serves as a hole blocking layer to prevent holes migrating toward the cathode. Additional components which may be present in an organic light-emitting device include hole transporting layers, hole transporting emission (emitting) layers and electron transporting emission (emitting) layers.

In one embodiment, the OLEDs comprising the polymers of the invention may be a fluorescent OLED comprising a singlet emitter. In another embodiment, the OLEDs comprising the polymers of the invention may be a phosphorescent OLED comprising at least one triplet emitter. In another embodiment, the OLEDs comprising the polymers of the invention comprise at least one singlet emitter and at least one triplet emitter. The OLEDs comprising the polymers of the invention may contain one or more, any or a combination of blue, yellow, orange, red phosphorescent dyes, including complexes of transition metals such as Ir, Os and Pt. In particular, electrophosphorescent and electrofluorescent metal complexes, such as those supplied by American Dye Source, Inc., Quebec, Canada may be used. Polymers comprising structural unit of any of formula I to VI may be part of an emissive layer, or hole transporting layer or electron transporting layer, or electron injection layer of an OLED or any combination thereof.

The organic electroluminescent layer, i.e., the emissive layer, is a layer within an organic light emitting device which when in operation contains a significant concentration of both electrons and holes and provides sites for exciton formation and light emission. A hole injection layer is a layer in contact with the anode which promotes the injection of holes from the anode into the interior layers of the OLED; and an electron injection layer is a layer in contact with the cathode that promotes the injection of electrons from the cathode into the OLED; an electron transport layer is a layer which facilitates conduction of electrons from the cathode and/or the electron injection layer to a charge recombination site. During operation of an organic light emitting device comprising an electron transport layer, the majority of charge carriers (i.e. holes and electrons) present in the electron transport layer are electrons and light emission can occur through recombination of holes and electrons present in the emissive layer. A hole transporting layer is a layer which when the OLED is in operation facilitates conduction of holes from the anode and/or the hole injection layer to charge recombination sites and which need not be in direct contact with the anode. A hole transporting emission layer is a layer in which when the OLED is in operation facilitates the conduction of holes to charge recombination sites, and in which the majority of charge carriers are holes, and in which emission occurs not only through recombination with residual electrons, but also through the transfer of energy from a charge recombination zone elsewhere in the device. An electron transporting emission layer is a layer in which when the OLED is in operation facilitates the conduction of electrons to charge recombination sites, and in which the majority of charge carriers are electrons, and in which emission occurs not only through recombination with residual holes, but also through the transfer of energy from a charge recombination zone elsewhere in the device.

Materials suitable for use as the anode includes materials having a bulk resistivity of preferred about 1000 ohms per square, as measured by a four-point probe technique. Indium tin oxide (ITO) is frequently used as the anode because it is substantially transparent to light transmission and thus facilitates the escape of light emitted from electro-active organic layer. Other materials, which may be utilized as the anode layer, include tin oxide, indium oxide, zinc oxide, indium zinc oxide, zinc indium tin oxide, antimony oxide, and mixtures thereof.

Materials suitable for use as the cathode include general electrical conductors including, but not limited to metals and metal oxides such as ITO etc which can inject negative charge carriers (electrons) into the inner layer(s) of the OLED. Various metals suitable for use as the cathode include K, Li, Na, Cs, Mg, Ca, Sr, Ba, Al, Ag, Au, In, Sn, Zn, Zr, Sc, Y, elements of the lanthanide series, alloys thereof, and mixtures thereof. Suitable alloy materials for use as the cathode layer include Ag—Mg, Al—Li, In—Mg, Al—Ca, and Al—Au alloys. Layered non-alloy structures may also be employed in the cathode, such as a thin layer of a metal such as calcium, or a metal fluoride, such as LiF, covered by a thicker layer of a metal, such as aluminum or silver. In particular, the cathode may be composed of a single metal, and especially of aluminum metal.

Materials suitable for use in electron transport layers include poly(9,9-dioctyl fluorene), tris(8-hydroxyquinolato) aluminum (Alq₃), 2,9-dimethyl-4,7-diphenyl-1,1-phenanthroline, 4,7-diphenyl-1,10-phenanthroline, 2-(4-biphenylyl)-5-(4-t-butylphenyl)-1,3,4-oxadiazole, 3-(4-biphenylyl)-4-phenyl-5-(4-t-butylphenyl)-1,2,4-triazole, 1,3,4-oxadiazole-containing polymers, 1,3,4-triazole-containing polymers, quinoxaline-containing polymers, and cyano-PPV.

Polymers comprising structural units of formula I to VI may be used in hole transporting layers in place of, or in addition to traditional materials such as 1,1-bis((di-4-tolylamino)phenyl)cyclohexane, N,N′-bis(4-methylphenyl)-N,N′-bis(4-ethylphenyl)-(1,1′-(3,3′-dimethyl)biphenyl)-4,4′-diamine, tetrakis-(3-methylphenyl)-N,N,N′,N′-2,5-phenylenediamine, phenyl-4-N,N-diphenylaminostyrene, p-(diethylamino)benzaldehyde diphenylhydrazone, triphenylamine, 1-phenyl-3-(p-(diethylamino)styryl)-5-(p-(diethylamino)phenyl)pyrazoline, 1,2-trans-bis(9H-carbazol-9-yl)cyclobutane, N,N,N′,N′-tetrakis(4-methylphenyl)-(1,1′-biphenyl)-4,4′-diamine, copper phthalocyanine, polyvinylcarbazole, (phenylmethyl)polysilane; poly(3,4-ethylendioxythiophene) (PEDOT), polyaniline, polyvinylcarbazole, triaryldiamine, tetraphenyldiamine, aromatic tertiary amines, hydrazone derivatives, carbazole derivatives, triazole derivatives, imidazole derivatives, oxadiazole derivatives having an amino group, and polythiophenes as disclosed in U.S. Pat. No. 6,023,371.

Materials suitable for use in the light emitting layer include electroluminescent polymers such as polyfluorenes, preferably poly(9,9-dioctyl fluorene) and copolymers thereof, such as poly(9,9′-dioctylfluorene-co-bis-N,N′-(4-butylphenyl)diphenylamine) (F8-TFB); poly(vinylcarbazole) and polyphenylenevinylene and their derivatives. In addition, the light emitting layer may include a blue, yellow, orange, green or red phosphorescent dye or metal complex, or a combination thereof. Materials suitable for use as the phosphorescent dye include, but are not limited to, tris(1-phenylisoquinoline) iridium (III) (red dye), tris(2-phenylpyridine) iridium (green dye) and Iridium (III) bis(2-(4,6-difluorephenyl)pyridinato-N,C2) (blue dye). Commercially available electrofluorescent and electrophosphorescent metal complexes from ADS (American Dyes Source, Inc.) may also be used. ADS green dyes include ADS060GE, ADS061GE, ADS063GE, and ADS066GE, ADS078GE, and ADS090GE. ADS blue dyes include ADS064BE, ADS065BE, and ADS070BE. ADS red dyes include ADS067RE, ADS068RE, ADS069RE, ADS075RE, ADS076RE, ADS067RE, and ADS077RE.

Polymers comprising structural unit of any of formula I to VI may form part of the hole transport layer or hole injection layer or light emissive layer of optoelectronic devices, e.g., OLEDs. The OLEDs may be phosphorescent containing one or more, any or a combination of, blue, yellow, orange, green, red phosphorescent dyes.

### DEFINITIONS

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), and anthraceneyl groups (n=3). The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehydes groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g. methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₂₀ aromatic radical” includes aromatic radicals containing at least three but no more than 20 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆-C₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀O—), 3-trimethylsilylcyclohex-1-yl, 2-t-butyldimethylsilylcyclopent-1-yl, 4-trimethoxysilylethylcyclohex-1-yl (e.g. (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” organic radicals substituted with a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g. —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e. —CHO), hexyl, hexamethylene, hydroxymethyl (i.e. —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₂₀ aliphatic radical contains at least one but no more than 20 carbon atoms. A methyl group (i.e., CH₃—) is an example of a C₁ aliphatic radical. A decyl group (i.e., CH₃(CH₂)₉—) is an example of a C₁₀ aliphatic radical.

The term “heteroaryl” as used herein refers to aromatic or unsaturated rings in which one or more carbon atoms of the aromatic ring(s) are replaced by a heteroatom(s) such as nitrogen, oxygen, boron, selenium, phosphorus, silicon or sulfur. Heteroaryl refers to structures that may be a single aromatic ring, multiple aromatic ring(s), or one or more aromatic rings coupled to one or more non-aromatic ring(s). In structures having multiple rings, the rings can be fused together, linked covalently, or linked to a common group such as an ether, methylene or ethylene moiety. The common linking group may also be a carbonyl as in phenyl pyridyl ketone. Examples of heteroaryl rings include thiophene, pyridine, isoxazole, pyrazole, pyrrole, furan, imidazole, indole, thiazole, benzimidazole, quinoline, isoquinoline, quinoxaline, pyrimidine, pyrazine, tetrazole, triazole, benzo-fused analogues of these groups, benzopyranone, phenylpyridine, tolylpyridine, benzothienylpyridine, phenylisoquinoline, dibenzoquinozaline, fluorenylpyridine, ketopyrrole, 2-phenylbenzoxazole, 2 phenylbenzothiazole, thienylpyridine, benzothienylpyridine, 3 methoxy-2-phenylpyridine, phenylimine, pyridylnaphthalene, pyridylpyrrole, pyridylimidazole, and phenylindole.

The term “aryl” is used herein to refer to an aromatic substituent which may be a single aromatic ring or multiple aromatic rings which are fused together, linked covalently, or linked to a common group such as an ether, methylene or ethylene moiety. The aromatic ring(s) may include phenyl, naphthyl, anthracenyl, and biphenyl, among others. In particular embodiments, aryls have between 1 and 200 carbon atoms, between 1 and 50 carbon atoms or between 1 and 20 carbon atoms.

The term “alkyl” is used herein to refer to a branched or unbranched, saturated or unsaturated acyclic hydrocarbon radical. Suitable alkyl radicals include, for example, methyl, ethyl, n-propyl, i-propyl, 2-propenyl (or allyl), vinyl, n-butyl, t-butyl, i-butyl (or 2-methylpropyl), etc. In particular embodiments, alkyls have between 1 and 200 carbon atoms, between 1 and 50 carbon atoms or between 1 and 20 carbon atoms.

The term “cycloalkyl” is used herein to refer to a saturated or unsaturated cyclic non-aromatic hydrocarbon radical having a single ring or multiple condensed rings. Suitable cycloalkyl radicals include, for example, cyclopentyl, cyclohexyl, cyclooctenyl, bicyclooctyl, etc. In particular embodiments, cycloalkyls have between 3 and 200 carbon atoms, between 3 and 50 carbon atoms or between 3 and 20 carbon atoms.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

### Examples

### Polymer Synthesis

Polymer III (TPD-NPB polymer) was prepared according to scheme 1 and scheme 2 using two different sets of monomers. Each of schemes 1 and 2 was repeated once, so sample Nos. 1-4 of polymer III were obtained.

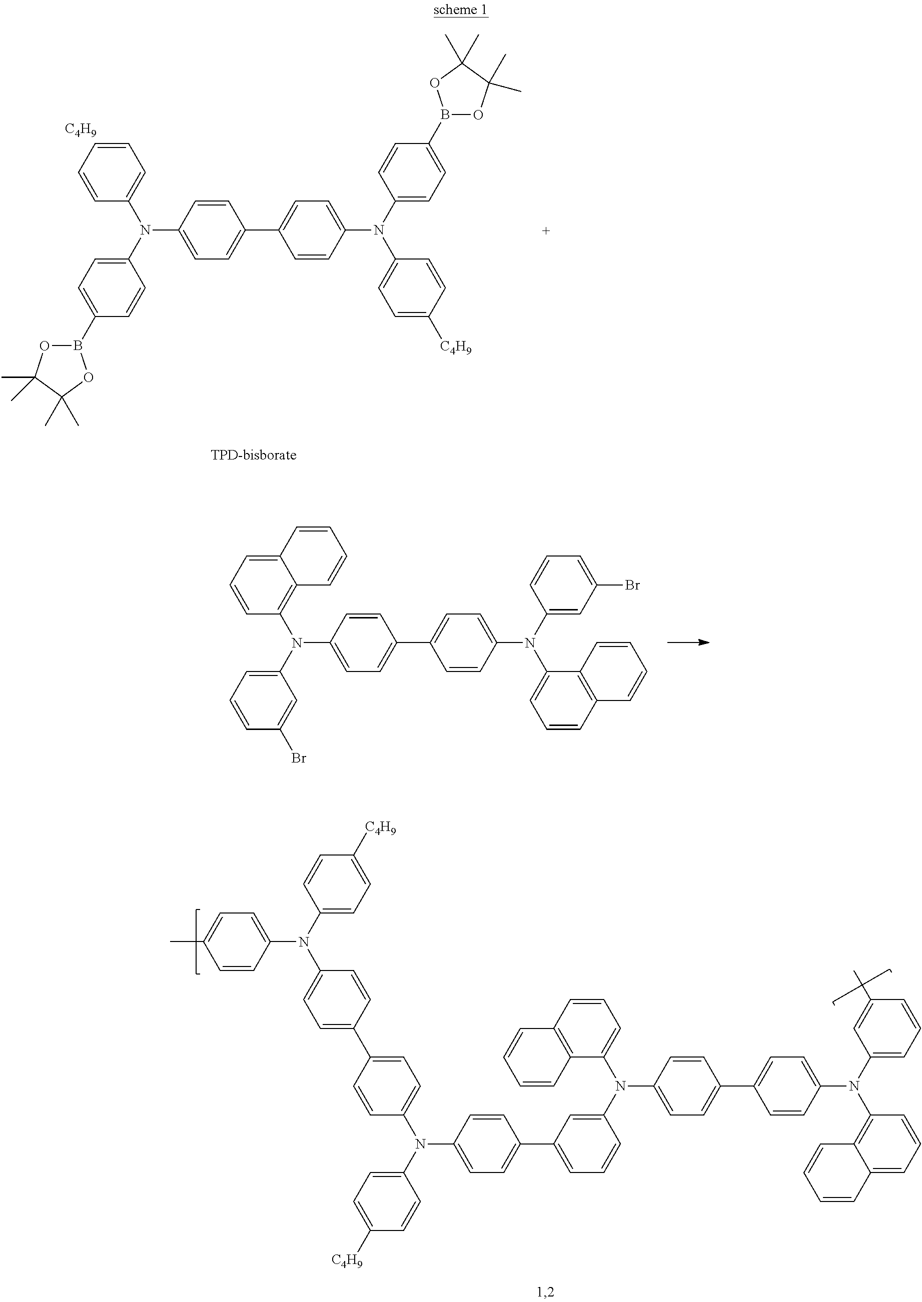

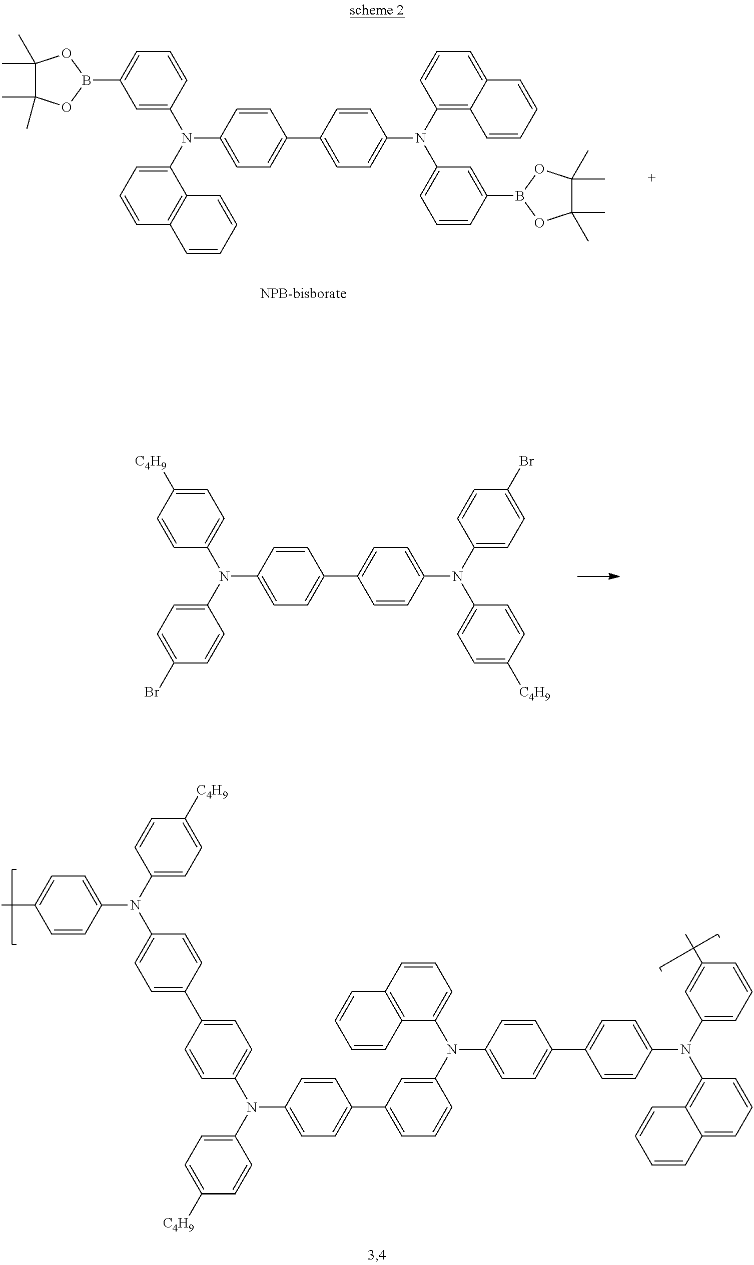

Polymer IV (fluorene-NPB copolymer), polymer V (m-phenyl-NPB copolymer) and polymer VI (2,5-fluorene-NPB copolymer) were prepared using schemes 3-5 to get sample Nos. 5-7, respectively.

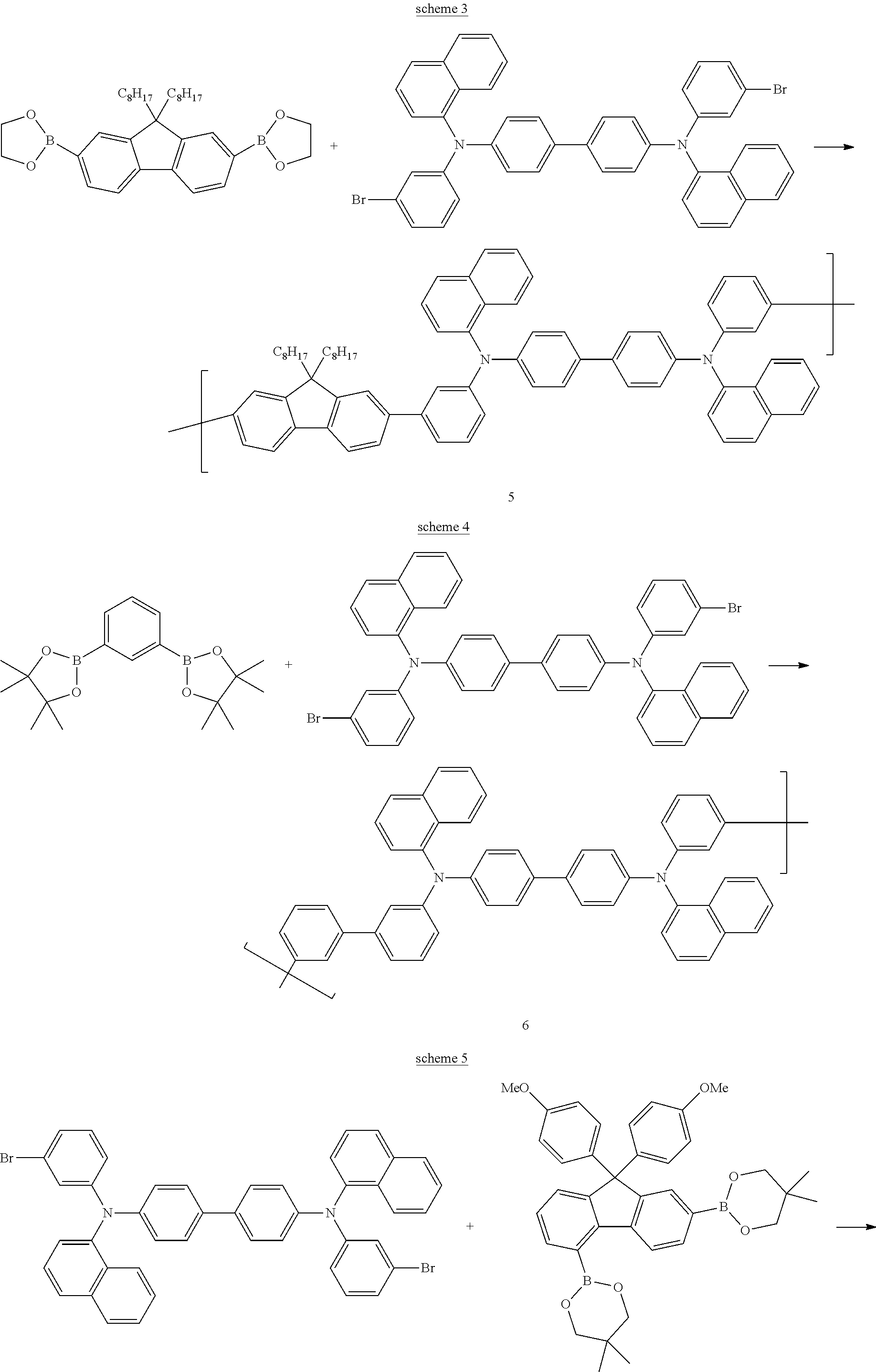

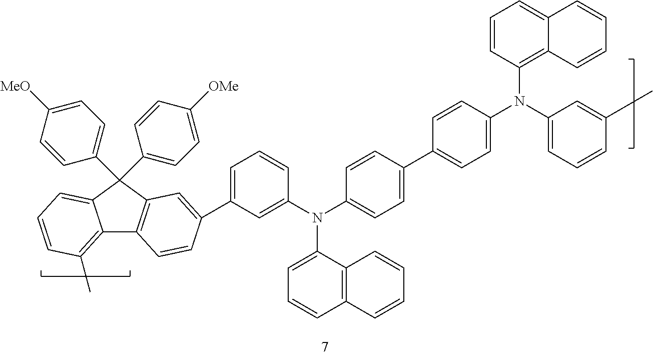

All materials required in polymerizations were charged according to Table 1.

TABLE 1

| Polymer | | dibro- | | | | Tolu- |
|---|---|---|---|---|---|---|
| sample | Bisborate | mide | Pd(OAc)₂ | Ligand | Et₄HOH | ene |
| No. | (g) | (g) | (mg) | (mg) | (g) | (mL) |
| 1 | 0.4264 | 0.3733 | 1.7 | 10.8 | 1.85 | 10 |
| 2 | 0.4264 | 0.3733 | 1.7 | 10.8 | 1.85 | 10 |
| 3 | 0.8528 | 0.7586 | 3.4 | 21.6 | 3.7 | 20 |
| 4 | 0.8528 | 0.7586 | 3.4 | 21.6 | 3.7 | 20 |
| 5 | 0.2651 | 0.3733 | 1.7 | 10.8 | 1.85 | 10 |
| 6 | 0.165 | 0.3733 | 1.7 | 10.8 | 1.85 | 10 |
| 7 | 0.2409 | 0.2986 | 1.7 | 10.8 | 1.44 | 10 |

Et₄NOH is 20% aqueous solution. Pd(OAc)₂ was recrystallized from acetone before use. The ligand is Aldrich No. 638072, 2-dicyclohexylphosphino-2′,6′-dimethoxy-biphenyl, with a structure below.

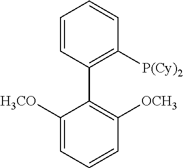

All monomers were dried in a vacuum oven for at least 2 hours prior to weighing. In a three neck round bottom flask (25 or 50 mL), Pd(OAc)₂ and the ligand were weighed out. To this flask was added two monomers together with toluene. Under a gentle stir, after all monomers were dissolved, the solution was degassed with a stream of argon for 15 minutes. The aqueous Et₄NOH solution was weighed out in a separate vial, transferred into an addition funnel and degassed with argon separately. After at least 15 minutes of degassing, the aqueous Et₄NOH solution was added to the organic solution in the flask in a dropwise fashion. The flask was then immersed in a 75° C. oil bath. Stirring and heating under a positive argon pressure continued for 24-48 hours. After analyzing the polymer with gel permeation chromatography (GPC), 0.5 mL of phenylboronic acid 1,3-propanediol ester in 2 mL of toluene (previously degassed) was added. The reaction mixture was kept at 75° C. for an additional hour. After that the flask was transferred to a nitrogen box.

### Polymer Isolation

All solvents were degassed using argon and all glasswares and tubes were dried before putting into nitrogen box the night before isolation.

The warm polymer solution was dropwise added into acetone solution (3 times of the polymer solution in volume) under rapid stifling. The solution was left still. Supernant was decanted away and the residue wrapped in aluminum foil was transferred to a centrifuge. After centrifuge, the polymer was transferred into the nitrogen box and the solvent was decanted away to yield powders. The powder was transferred to a vial and re-dissolved using hot toluene (˜0.5 g polymer versus about 15-20 mL of toluene). Then to this solution 4 fold amount of amine-functionalized silica gel was added and stirred on a hot plate at 70-90° C. to keep the polymer in solution. This heating processing took an hour. Then the solution was filtered through a fluted filter paper. About 10-20 mL of hot toluene was used to wash and solve the residue polymer. To this polymer solution acetone was added until it becomes cloudy. It took about 40:14 toluene:acetone ratio. Then the solution was left stand still and the cloudy supernatant was decanted away. Hot toluene was added to re-dissolve the gum left in the flask and acetone solution (¼ of toluene in volume) was dropwise added. The polymer was collected by centrifuge, washed with pure acetone, followed by twice centrifuge and decanting, and dried in the glove box overnight. Molecular weight (Mw) characterization and thermal characterization were analyzed in next day.

### Mw Characterization

Molecular weights were measured using gel permeation chromatography on a mixed C column with column oven at 40° C. using 3.75% v/v iso-propanol in chloroform as the eluting solvent and molecular weights were referred to polystyrene standards. Table 2 below shows results.

TABLE 2

| Polymer sample No. | Mw(g/mol) | PDI |
|---|---|---|
| 1 | 6827 | 1.67 |
| 2 | 18825 | 2.64 |
| 3 | 53404 | 2.6 |
| 4 | 55000 | 2.2 |
| 5 | 57216 | 4.47 |
| 6 | 16000 | |
| 7 | 5871 | 1.6 |

### Thermal Characterization

The samples were cut and weighed into Tzero hermetic aluminum sample pans and analyzed on TA Instrument's Q1000 Differential Scanning Calorimeter, serial number 1000-0386 under a 50 mL/min nitrogen purge and a heat rate of 10° C./min. Table 3 shows results of sample No. 5.

TABLE 3

| Polymer sample No. | Tg Onset (° C.) | Tg Midpoint (° C.) | Ramp |
|---|---|---|---|
| 5 | 157 | 161 | 2 |
| | 157 | 161 | 3 |
| | 157 | 161 | 4 |
| 5 | 157 | 162 | 2 |
| | 159 | 163 | 3 |
| | 158 | 163 | 4 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A polymer comprising structural unit of formula I: 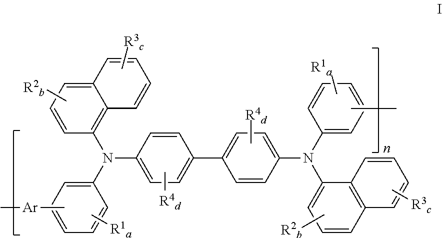
wherein
Ar is heteroaryl or aryl, other than formula I;
R¹, R², R³ and R⁴ are, independently at each occurrence, a C₁-C₂₀ aliphatic radical, a C₃-C₂₀ aromatic radical, or a C₃-C₂₀ cycloaliphatic radical;
a, c and d are, independently at each occurrence, an integer ranging from 0-4;
b is an integer ranging from 0-3; and
n is an integer greater than 3.

2. The polymer of claim 1, comprising structural unit of formula II:

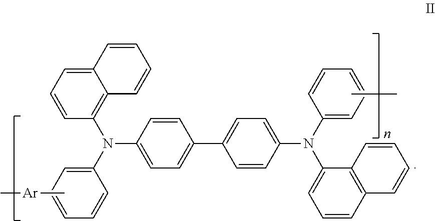

3. The polymer of claim 1, wherein Ar is selected from

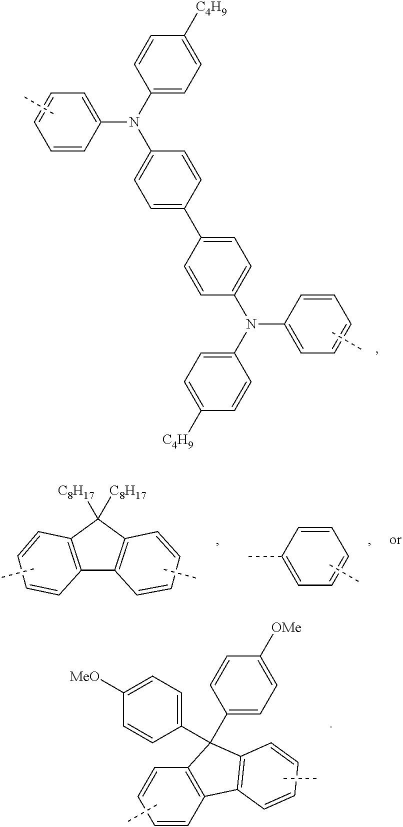

4. The polymer of claim 1, comprising structural unit of formula

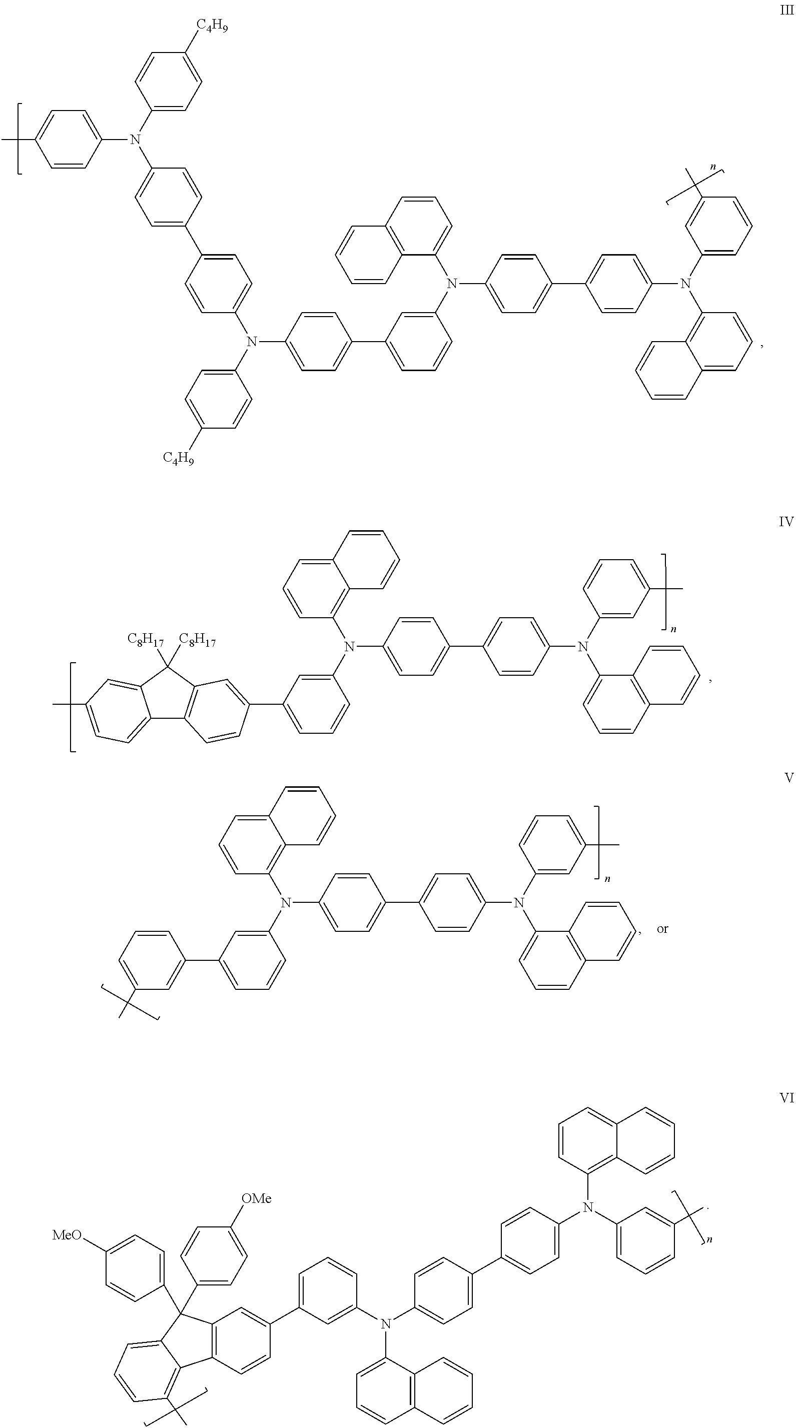

5. The polymer of claim 1, comprising structural unit of formula

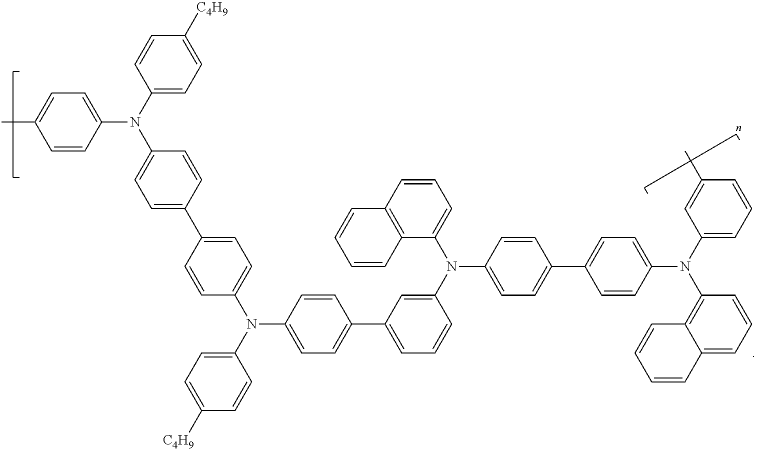

6. The polymer of claim 1, comprising structural unit of formula

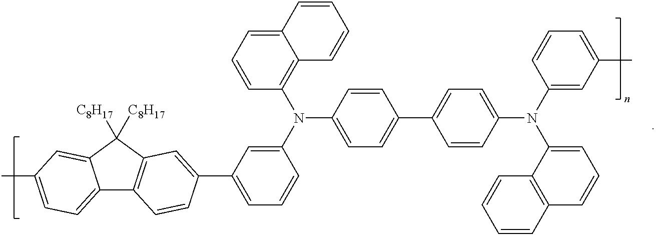

7. The polymer of claim 1, comprising structural unit of formula

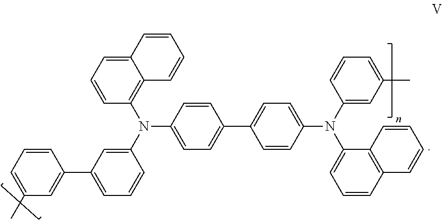

8. The polymer of claim 1, comprising structural unit of formula

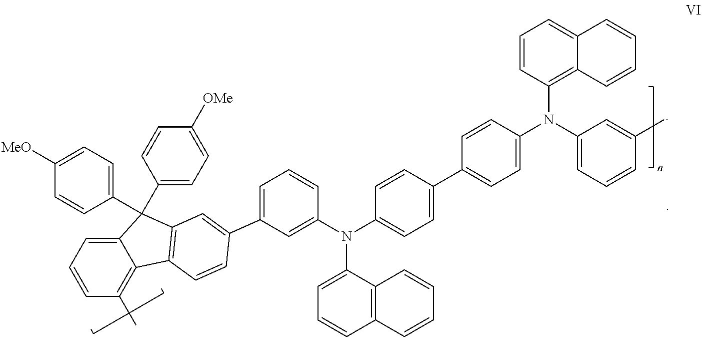

9. The polymer of claim 1, comprising structural units derived from

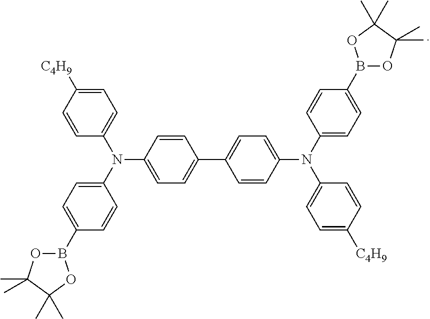

10. The polymer of claim 1, comprising structural units derived from

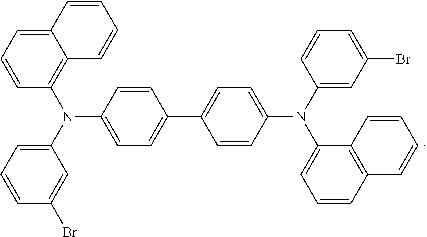

11. The polymer of claim 1, comprising structural units derived from

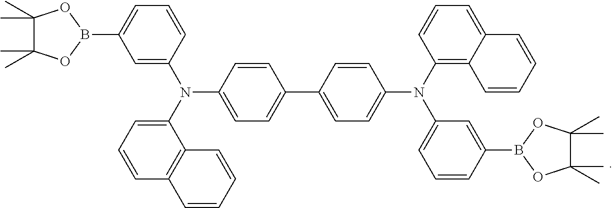

12. The polymer of claim 1, comprising structural units derived from

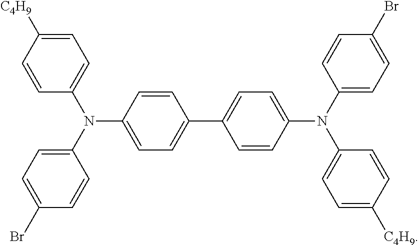

13. The polymer of claim 1, comprising structural units derived from

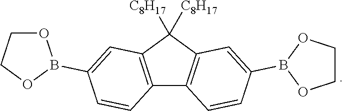

14. The polymer of claim 1, comprising structural units derived from

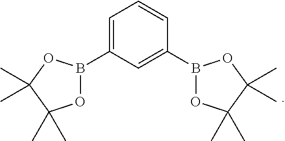

15. The polymer of claim 1, comprising structural units derived from

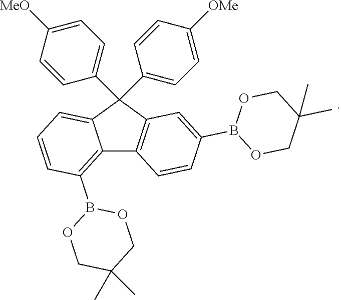

16. An optoelectronic device comprising a polymer of claim 1.

17. The optoelectronic device of claim 16, wherein the polymer comprises structural unit of formula II:

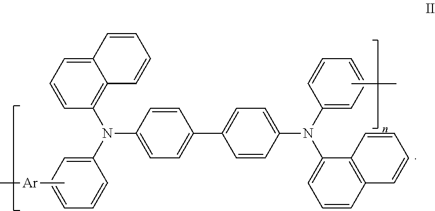

18. The optoelectronic device of claim 16, wherein Ar is selected from

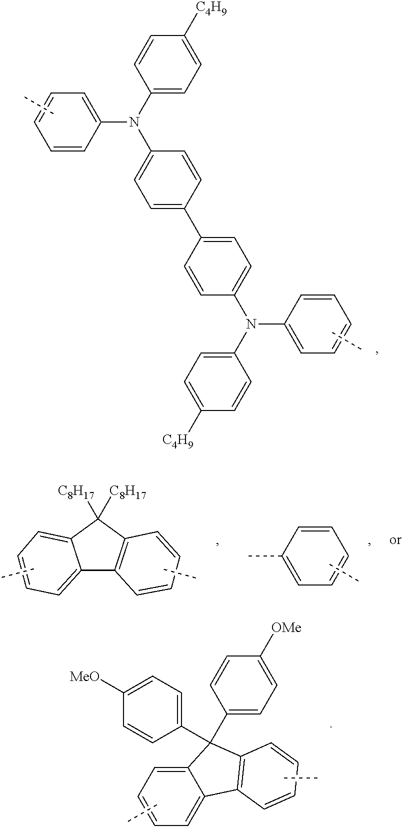

19. The optoelectronic device of claim 16, wherein the polymer comprises structural unit of formula

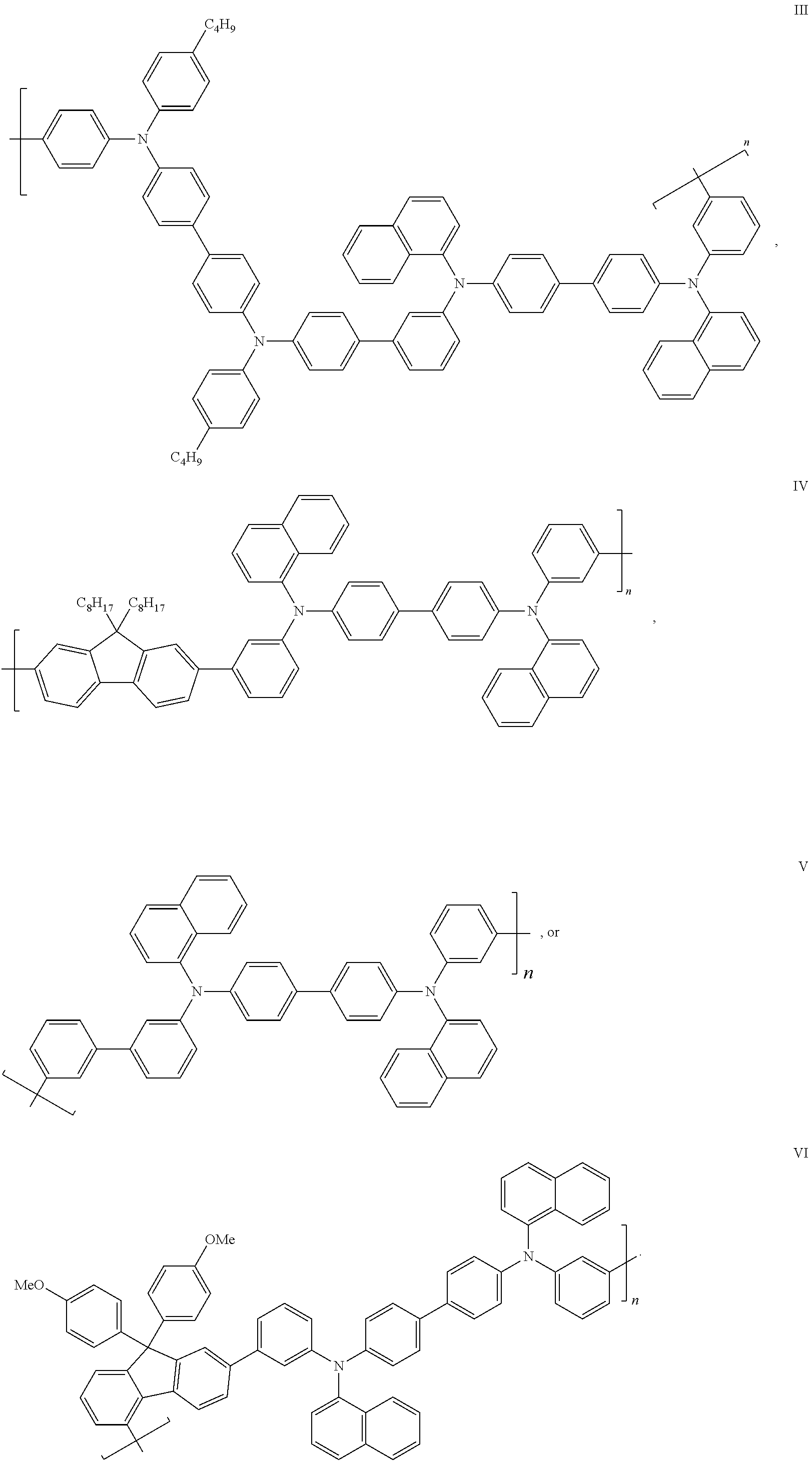

20. The optoelectronic device of claim 16, wherein the polymer comprises structural units derived from 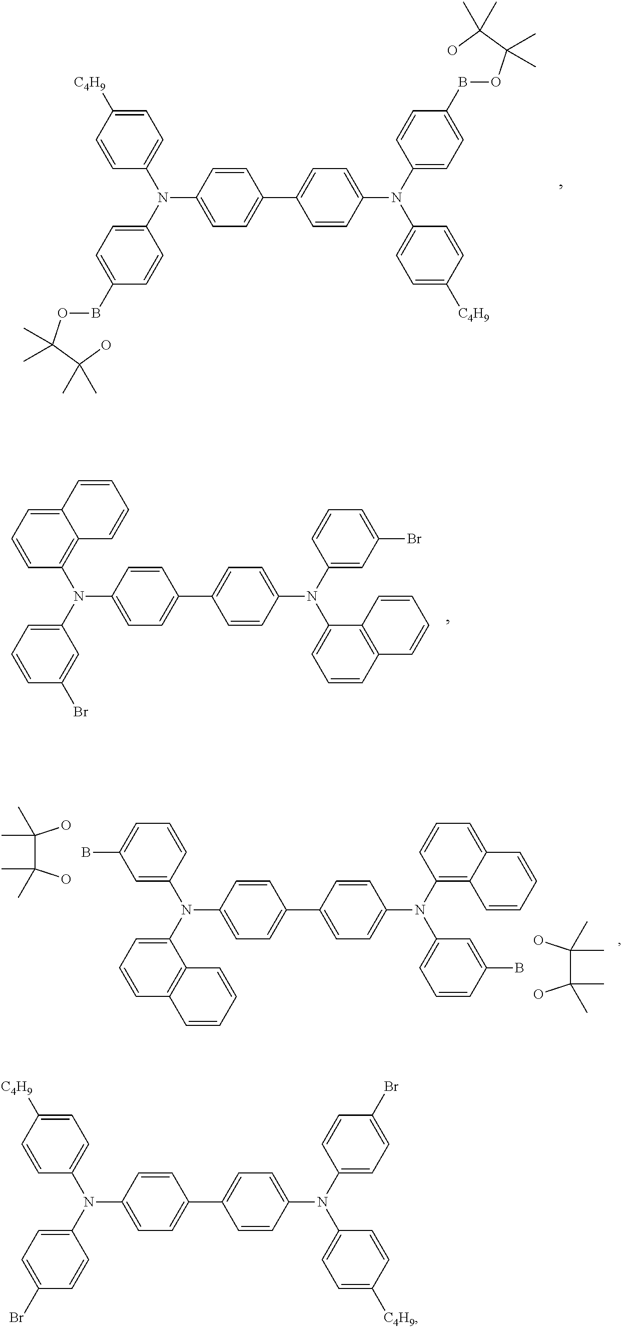 [chemical structure]
